(19) United States
(12) Patent Application Publication
(10) Pub. No.: US 2007/0009240 A1
(43) Pub. Date: Jan. 11, 2007

(54) Semiconductor test device

(76) Inventors: Naomi Miyake, Mishima-gun (JP); Minoru Sanada, Takatsuki-shi (JP)

Correspondence Address: MCDERMOTT WILL & EMERY LLP, 600 13TH STREET, N.W., WASHINGTON, DC, 20005-3096, US

(21) Appl. No.: 11/480,485

(22) Filed: Jul. 5, 2006

(30) Foreign Application Priority Data
Jul. 5, 2005 (JP) 2005-196522

(51) Int. Cl. A21B 2/00; F26B 19/00

(52) U.S. Cl. 392/416

(57) ABSTRACT

A semiconductor test device comprises a substrate having a opposed-wafer surface on which a semiconductor wafer with a plurality of the embedded semiconductor devices is placing opposite when a burn-in test is implemented, a wiring layer provided on the substrate, and a temperature sensor for measuring a temperature of the semiconductor wafer in the state here the semiconductor wafer is placing opposite on the substrate, wherein the wiring layer includes a wiring which is connected to the semiconductor wafer in the state where the semiconductor wafer is placing opposite on the substrate, and supplies a signal and a voltage for the burn-in test to the semiconductor wafer, and the temperature sensor is provided on the substrate in vicinity of the opposed-wafer surface.

### BACKGROUND OF THE INVENTION

1. Field of the Invention

The present invention relates to a semiconductor test device, more specifically to a burn-in technology in which a semiconductor wafer collective probe is used.

2. Description of the Related Art

An accelerated test is conventionally implemented to a semiconductor device and a semiconductor wafer, in other words, the semiconductor device and the semiconductor wafer are operated at a high temperature and a high voltage in order to detect in advance a defective product in which any defect is exposed at actual usage immediately after it is manufactured. The test is called “burn-in”. In recent years, a technology for collectively implementing the burn-in per wafer (hereinafter, referred to as wafer level burn-in), which is recited in U.S. Pat. No. 5,210,485, was developed. In the wafer level burn-in, a high voltage and a signal are respectively inputted to a power-supply terminal and a plurality of input/output terminals in order to make each device to be operated.

There is an ongoing rapid advancement in recent years in an increasing diameter of the semiconductor wafer and miniaturization of a semiconductor process. It has been pointed out as a disadvantage brought by the miniaturization that heat generation increases, and as its factors, an increase of power consumption in the semiconductor wafer accompanied by the miniaturization is pointed out. A power-supply current (off-leak) increases due to the increasing power consumption in the semiconductor wafer, and the heat generation in also increased by self-heating of the semiconductor device and parasitic resistance in a burn-in processing device.

Usually, it is unlikely that all of the semiconductor devices manufactured on the semiconductor wafer are a non-defective product, and the defective device and the non-defective device are present in a mixed state on the semiconductor wafer. The defective device concerned means a defective device that is confirmed to be present before the burn-in processing, and is hereinafter referred to as an already-detected defective device. It is often the case that when the wafer level burn-in is performed to the semiconductor wafer thus characterized, a high temperature/high voltage stress is applied to only the non-defective device, and the already-detected defective device is insulated in order to be not operated. In that case, a temperature difference between the non-defective device and the already-detected defective device is increased when the self-heating of the semiconductor device is increased.

In the conventional technology, a temperature sensor is provided for temperature management in the burn-in processing at a position in a relatively large distance from the semiconductor wafer. According to such a layout of the temperature sensor, an actual temperature cannot be accurately monitored when the semiconductor wafer is subjected to the burn-in due to the heat generation of the semiconductor wafer and a heat resistance of a component constituting the burn-in processing device in close contact with the semiconductor wafer. Further, it cannot be conducted to accurately control a heating temperature as the influence of the heat resistance has to be taken into account due to the large distance between the semiconductor wafer and the temperature sensor.

### SUMMARY OF THE INVENTION

Therefore, a main object of the present invention is to provide a semiconductor test device capable of accurately monitoring an actual temperature of a semiconductor wafer and accurately controlling the temperature of the semiconductor wafer in order to enhance reliability of the wafer level burn-in.

In order to solve the foregoing problem, a semiconductor test device according to the present invention comprises:

a substrate having an opposed-wafer surface on which a semiconductor wafer with a plurality of the embedded semiconductor devices is placed opposite when a burn-in test is implemented;

a wiring layer provided on the substrate; and

a temperature sensor for measuring a temperature of the semiconductor wafer in the state where the semiconductor wafer is placed in an opposed state on the substrate, wherein

the wiring layer includes a wiring which is connected to the semiconductor wafer in the state where the semiconductor wafer is placed in an opposed state on the substrate so that a signal and a voltage for the burn-in test are supplied to the semiconductor wafer, and

the temperature sensor is provided to the substrate in vicinity of the opposing surface for wafer.

According to the foregoing constitution, the temperature sensor is provided in the vicinity of the opposing surface for wafer of the substrate, which means that the temperature sensor is getting as closely as possible to the semiconductor wafer. Then, the temperature of the semiconductor wafer can be detected in the close vicinity of the semiconductor wafer. As a result, the actual temperature of the semiconductor wafer can be accurately monitored, which enhances the reliability of the wafer level burn-in.

In the foregoing constitution, the temperature sensor is preferably provided on the opposed-wafer surface of the substrate. As an optional mode of the foregoing constitution, an anisotropic conductive rubber sheet is placed on the substrate, a flexible substrate is further attached thereon, and thereafter the temperature sensor is provided on the flexible substrate. However, the temperature sensor may be directly provided on the opposed-wafer surface of the substrate without placing the anisotropic conductive rubber sheet and the flexible substrate. The latter structure is preferable in order to accurately monitor the actual temperature of the semiconductor wafer.

It is preferable that the temperature sensor consists of a part of the wiring layer. Accordingly, the wiring layer can include a resistance component, and the temperature can be obtained from a resistance value and a temperature coefficient of resistance at a reference temperature.

It is preferable that a plurality of the temperature sensors is provided, wherein a location distribution of the plurality of temperature sensors on the substrate corresponds to a wiring distribution density of the wiring layer on the substrate. Thereby, the accuracy in the temperature detection is enhanced as a number of points of the temperature measurement is increased.

A terminal is preferably provided in a periphery of the substrate, wherein the temperature sensor and the terminal are connected to each other via the wiring layer. Thereby, a temperature detection signal from the temperature sensor can be outputted from the terminal to an external temperature adjusting circuit.

A semiconductor test device according to the present invention comprises:

a substrate having a opposed-wafer surface on which a semiconductor wafer with a plurality of the embedded semiconductor devices is placed opposite when a burn-in test is implemented;

a wiring layer provided on the substrate; and

a temperature adjuster for adjusting a temperature of the semiconductor wafer in the state where the semiconductor wafer is placed opposite on the substrate, wherein

the wiring layer includes wirings which are connected to the semiconductor wafer in the state where the semiconductor wafer is placed in an opposed state on the substrate so that a signal and a voltage for the burn-in test are supplied to the semiconductor wafer, and

the temperature adjuster is provided on the substrate in vicinity of the opposed-wafer surface.

According to the foregoing constitution, the temperature adjuster is provided in the vicinity of the opposed-wafer surface of the substrate, which means that the temperature adjuster is getting as closely as possible to the semiconductor wafer. Thereby, the temperature of the semiconductor wafer can be detected in the close vicinity of the semiconductor wafer. As a result, the temperature of the semiconductor wafer can be accurately controlled, which enhances the reliability of the wafer level burn-in.

Further, it is preferable that the temperature adjuster is provided on the opposed-wafer surface of the substrate. As an optional mode of the foregoing constitution, an anisotropic conductive rubber sheet is laid on the substrate, a flexible substrate is further attached thereon, and thereafter the temperature adjuster is provided on the flexible substrate. However, the temperature adjuster may be directly provided on the opposed-wafer surface of the substrate without placing the anisotropic conductive rubber sheet and the flexible substrate. The latter constitution is preferable in order to accurately monitor the actual temperature of the semiconductor wafer.

The temperature adjuster is preferably composed of a part of the wiring layer. Accordingly, the wiring can include a resistance component, and the temperature can be adjusted by power consumed in the wirings through conducting.

It is preferable that a plurality of the temperature adjusters is provided, wherein the plurality of the temperature adjusters is each constructed to be able to be separately adjusted. Accordingly, even in the case that there is a variation in existence of the non-defective semiconductor device and the already-detected defective semiconductor device in the semiconductor wafer, the temperature adjuster provided in an alignment portion of the already-detected defective device is heat-generated so that the heat generation in the semiconductor wafer is apparently made homogeneous. As a result, the temperature control in the semiconductor wafer can be realized at a higher accuracy.

Number of the temperature adjusters and an adjustment capacitance of each of the temperature adjusters are preferably set based on a size of the semiconductor wafer, a size of each of the semiconductor devices, and power consumption of the semiconductor devices. By doing this, it can be corresponded to various changes of test conditions.

A terminal is preferably provided in a periphery of the substrate, wherein the temperature adjuster and the terminal are connected to each other via the wiring layer. Thereby, a condition-setting signal from the temperature adjuster can be supplied from the external temperature adjusting circuit to the temperature adjuster via the terminal.

A semiconductor test device according to the present invention comprises:

a substrate having a opposed-wafer surface on which a semiconductor wafer with a plurality of the embedded semiconductor devices is placed opposite when a burn-in test is implemented;

a wiring layer provided on the substrate;

a temperature sensor for measuring a temperature of the semiconductor wafer in the state where the semiconductor wafer is placed opposite on the substrate;

a temperature adjuster for adjusting the temperature of the semiconductor wafer in the state where the semiconductor wafer is placed opposite on the substrate, wherein

the wiring layer includes a wiring which is connected to the semiconductor wafer in the state where the semiconductor wafer is placed opposite on the substrate in order to supply a signal and a voltage for the burn-in test to the semiconductor wafer,

the temperature sensor and the temperature adjuster are provided on the substrate in vicinity of the opposed-wafer surface, and

the burn-in test is implemented while the temperature of the semiconductor wafer is being adjusted by the temperature adjuster based on the temperature of the semiconductor wafer measured by the temperature sensor.

According to the foregoing constitution, the actual temperature of the semiconductor wafer can be accurately monitored, and the temperature control in the semiconductor wafer can be accurate because the temperature adjuster and the temperature sensor are provided in the vicinity of the opposed-wafer surface. As a result, the reliability of the wafer level burn-in can be further enhanced.

The temperature sensor and the temperature adjuster are preferably provided on the opposed-wafer surface of the substrate.

A part of the wiring layer preferably constitutes the temperature sensor and the temperature adjuster.

It is preferable that a plurality of terminals is provided in a periphery of the substrate, wherein the temperature sensor and one of the terminals are connected to each other via the wiring layer, and the temperature adjuster and the other terminal are connected to each other via the wiring layer. Accordingly, the temperature detection signal from the temperature sensor can be outputted to the external temperature adjusting circuit via one of the terminals, while the condition setting signal set in the external temperature adjusting circuit can be supplied to the temperature adjuster via the other terminal.

According to the present invention, the temperature in the close vicinity of the semiconductor wafer can be confirmed, and the accurate temperature adjustment can be realized. As a result, the reliability of the wafer level burn-in can be increased. Further, when the plurality of temperature sensors is provided, the variation in the heat generation in the surface of the semiconductor wafer can be controlled at a high accuracy. The semiconductor test device according to the present invention can be applied to such usages as a temperature adjustment function of the wafer level burn-in, probe test and the like.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a bottom view of a semiconductor test device according to a preferred embodiment 1 of the present invention.

FIG. 2A is a bottom view of a semiconductor test device according to a preferred embodiment 2 of the present invention.

FIG. 2B is an enlarged view of a main part illustrating a specific example of a temperature adjuster.

FIG. 3 shows a semiconductor test device according to a preferred embodiment 3 of the present invention (bottom view) and a temperature adjusting circuit.

FIG. 4A is an enlarged sectional view of a basic structure of a semiconductor test device by which the present invention is applied.

FIG. 4B is a schematic sectional view of the semiconductor test device by which the present invention is applied.

FIG. 5 is a bottom view of the semiconductor test device by which the present invention is applied.

### DETAILED DESCRIPTION OF THE INVENTION

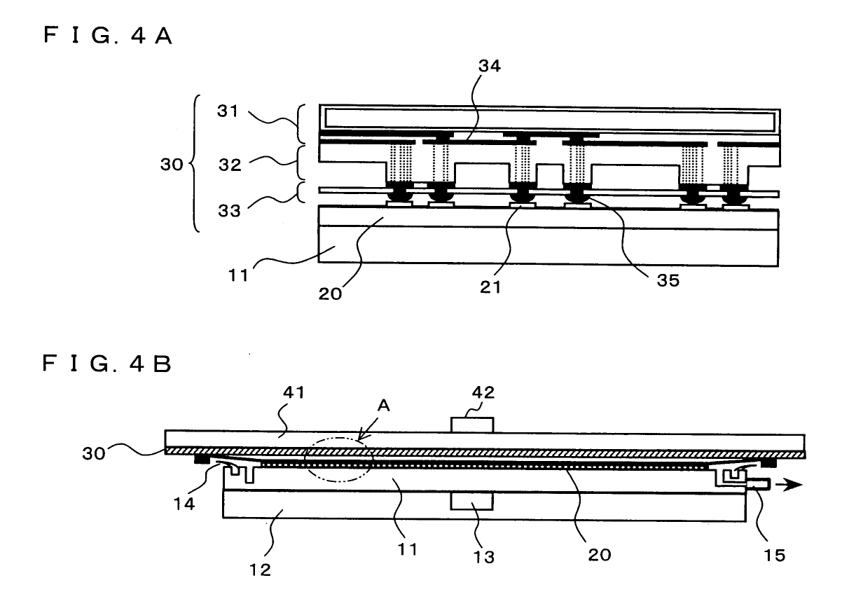

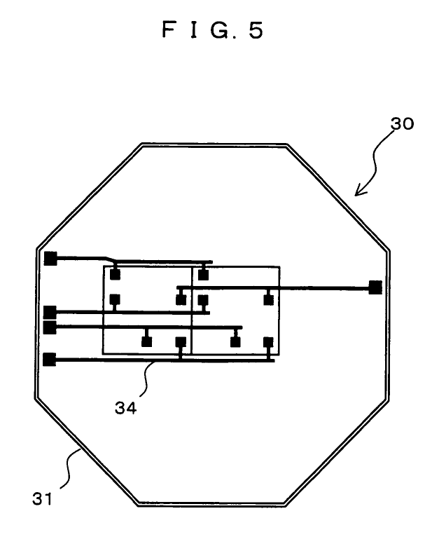

Before preferred embodiments of the present invention are described, an example of a basic structure of a probe (semiconductor test device) in the wafer level burn-in by which the present invention is performed is described referring to FIGS. 4A, 4B and 5. FIG. 4A is an enlarged sectional view of a probe 30. FIG. 4B is a schematic sectional view of the probe 30. FIG. 5 is a bottom view of the probe 30. In FIG. 4A, a part A shown in FIG. 4B is enlarged.

As shown in FIG. 4B, a semiconductor wafer (silicon wafer) 20 is placed on a wafer tray 11, and a temperature adjuster (heater) 12 is laid on a lower surface of the wafer tray 11. A temperature sensor 13 is attached to between the lower surface of the wafer tray 11 and the temperature adjuster 12. A vacuum sealing 14 is provided on an outer peripheral surface of the wafer tray 11. A vacuum valve 15 for opening and closing a vacuum suction passage to operate the vacuum sealing 14 is mounted.

A temperature adjuster (heater) 41 is provided on an upper surface of the probe 30. A temperature sensor 42 is attached to an upper surface of the temperature adjuster 41. The probe 30 comprises a multi-layer wiring substrate 31, an anisotropic conductive rubber sheet 32 of localization type and a flexible substrate 33 as shown in FIG. 4A. A wiring layer 34 is provided below the multi-layer wiring substrate 31. The anisotropic conductive rubber sheet 32 is provided below the wiring layer 34. Bumps 35 are provided on lower surfaces of protruding parts of the anisotropic conductive rubber sheet 32. The bumps 35 are connected to the wiring layer 34 inside the anisotropic conductive rubber sheet 32. The bumps 35 are pressed onto aluminum electrodes 21 of the semiconductor wafer 20 to be in contact therewith, and are fixed to the flexible substrate 33. The aluminum electrodes 21 are provided on the semiconductor wafer 20 for signal input/output and power supply.

Next is described the wafer level burn-in in which the probe 30 is used. The semiconductor wafer 20 is mounted on the wafer tray 11, vacuum suction is carried out via the vacuum valve 15, so that the vacuum sealing 14 is brought into close contact with the probe 30. More specifically, the bumps 35 of the probe 30 are pressed onto the aluminum electrodes 21 of the semiconductor wafer 20 through the vacuum suction. An electrical signal and a voltage are supplied from a burn-in device, not shown, to the multi-layer wiring substrate 31 of the probe 30. The electrical signal and the voltage are transmitted to respective semiconductor devices of the semiconductor wafer 20 via the wiring layer 34, anisotropic conductive rubber sheet 32, bumps 35 and aluminum electrodes 21. Then, outputs of the respective semiconductor devices of the semiconductor wafer 20 are transmitted to the burn-in device via the aluminum electrodes 21, bumps 35 and multi-layer wiring substrate 31. In this state, further, the semiconductor wafer 20 is subjected to the burn-in processing at a desired temperature while heating and cooling are controlled by the upper and lower temperature adjusters 41 and 12. The temperatures of the temperature sensors 42 and 13 are monitored and fed back to the temperature adjusters 41 and 12.

Hereinafter, the preferred embodiments of the present invention are described referring to the drawings.

### PREFERRED EMBODIMENT 1

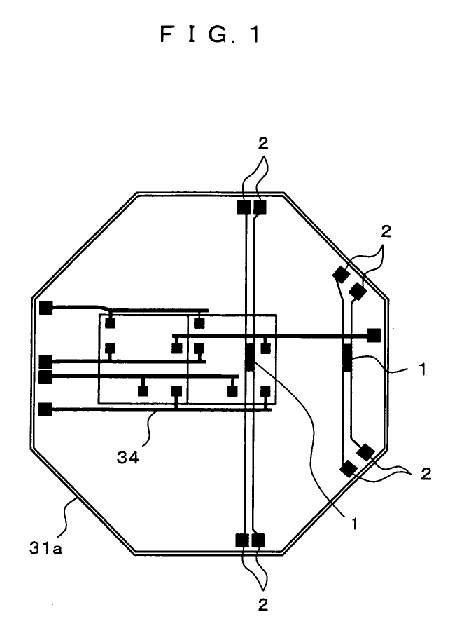

A preferred embodiment 1 of the present invention relates to alignment of temperature sensors. FIG. 1 is a bottom view of a semiconductor test device (probe) according to the preferred embodiment 1. In FIG. 1, a reference symbol 31a denotes a multi-layer wiring substrate. The multi-layer wiring substrate 31a corresponds to the multi-layer wring substrate 31 shown in the constitution of FIG. 4. A reference numeral 34 denotes a wiring layer of the multi-layer wiring substrate 31a. A reference numeral 1 denotes a temperature sensor, and 2 denotes a terminal. In the temperature sensors 1, measuring conditions are set from outside via at least one of the terminals 2, and outputs of the temperature sensors 1 are outputted outside via at least one of the terminals 2 and monitored. The rest of the constitution is similar to that of FIG. 4 described earlier, and not described in detail again.

The temperature sensors 1 are provided on a opposed-wafer surface of the multi-layer wiring substrate 31a. Testing surfaces of the temperature sensors 1 are flush with the opposed-wafer surface and exposed out of the opposed-wafer surface.

The terminals 2 are provided in a periphery of the multi-layer wiring substrate 31a. The temperature sensors 1 are respectively provided in a substantially central part and apart slightly closer to the periphery of the multi-layer wiring substrate 31a. The terminals 2 are provided in association with the respective temperature sensors 1. The respective temperature sensors 1 and the terminals 2 corresponding to the sensors 1 are connected to each other via the wirings constituting the wiring layer 34. The temperature sensors 1 are provided in such a manner as being exposed to the opposed-wafer surface of the multi-layer wiring substrate 31a so that the temperature of the semiconductor wafer 20 is detected in close vicinity of the semiconductor wafer 20.

In the wafer level burn-in, an electrical signal and a voltage are supplied to the multi-layer wiring substrate 31a from a burn-in device not shown. The electrical signal and the voltage are supplied to semiconductor devices of the semiconductor wafer 20 via the wirings constituting the wiring layer 34. The semiconductor devices and the multi-layer wiring substrate 31a may be connected in a manner similar to the basic structure described earlier (see FIGS. 4A and 4B), however, may be connected otherwise except for the basic structure. More specifically, without placing the anisotropic conductive rubber sheet and the flexible substrate, the wiring layer 34 can be directly provided in an opposed manner relative to the semiconductor devices to be connected therewith. The latter structure is preferable in order to monitor the actual temperature of the semiconductor wafer at a high accuracy.

The semiconductor devices are thus operated by the supplied electrical signal and voltage to thereby initiate self-heat generation. The conventional burn-in is often performed at a temperature at least 100° C., however, an external temperature adjuster (not shown) supports the heat generation when a predetermined temperature cannot be attained from the heat generation of the devices. When the temperature exceeds the predetermined temperature in the self heat generation of the devices, on the contrary, the heat generating part is cooled down to be reduced to the predetermined temperature by the external temperature adjuster. The temperature sensors 1 are thus directly provided on the opposed-wafer surface of the multi-layer wiring substrate 31a so that the temperature of the semiconductor wafer is detected in the close vicinity thereof. As a result, a high accuracy can be obtained in the measurement of the temperature.

The temperature of the semiconductor wafer detected by the temperature sensors 1 is converted into an electrical signal and outputted outside from the terminals 2B, and feedback control of the temperature adjuster externally provided is executed. There is a method available, for example, in which a resistor constitutes the temperature sensors 1, a voltage is applied to the resistor, and the temperature is measured from a variation of an obtained resistance value. The following equation is thought as a formula to calculate the temperature. There is a property that a resistance of metal is increasing in proportion to a temperature, and a temperature coefficient of resistance (TCR), which denotes a gradient of the increase, is different in each substance. The temperature coefficient of resistance is a rate of change of the resistance value per 1° C. at a designated temperature in a working temperature range. In order to calculate the temperature coefficient of resistance, the temperatures are set at two points so that the resistance value is calculated. For example, a temperature coefficient of resistance α is calculated in the following equation (1) from a resistance R[25] at 25° C. and a resistance R[125] at 125° C.
α=(R[125]÷R[25]−1)÷(125° C.−25° C.) (1)

When the temperature coefficient of resistance α is calculated, a measured temperature T [° C.] is calculated in the following equation (2).
T=(R[TA]÷R[25]−1)÷α+25° C. (2)

R[TA]: resistance of temperature sensor

In general, the temperature coefficient of resistance of metal in a thin-film state shows a value in the range of 100-1,000 ppm/° C. Apart of the wiring layer 34 can constitute the temperature sensor 1. For example, in the case where a wiring resistance is 500Ω, and the temperature coefficient of resistance is 1,000 ppm/° C., the resistance value changes by 5Ω when the temperature changes by 10° C., and the resistance value changes by 50Ω when the temperature changes by 100° C. The changes of the resistance are such numeral values that can be measured by a general resistance measurement device without any problem. Therefore, the wirings constituting the wirings 34 can be used as the wiring resistance to constitute the temperature sensor 1. When the temperature is measured based on the wiring resistance, a four-terminal measuring method is preferably used, wherein the temperature can be more accurately measured in such a manner that terminals are separated into a terminal for setting the conditions and a terminal for measuring the resistance. In the four-terminal measurement, the four terminals are provided in one temperature sensor.

In FIG. 1, the temperature sensors 1 are provided at the two points, which are the central part and the right-end part of the multi-layer wiring substrate 31a. If the temperature sensors 1 are provided in left, upper and lower points other than the foregoing two points, five in total, the entire surface can be substantially generally covered. The increase of the measurement points improves the accuracy. However, when a result of the temperature measurement is fed back so that the temperatures of the wafer and the substrate are controlled, it becomes more difficult to control the temperatures as the measurement points are increased. Further, in addition to the measurement results at the foregoing five points, the temperatures at other than the measuring points are approximately calculated based on the alignment positions of the non-defective device and the already-detected defective device and heating values of the non-defective device in the semiconductor wafer so that a temperature distribution of the entire semiconductor wafer can be interpolated.

In recent years, the power consumption is continuously increasing in performing the wafer level burn-in of the semiconductor devices formed on the semiconductor wafer as the miniaturization of the semiconductor process advances (3-4 times as much in comparison to a level in the year 2000). Therefore, the resistance of the power-supply wiring on the substrate is becoming a problem by involving the increase of the power consumption as described earlier. More specifically, power is consumed by a current flow generated in the presence of a minor power-supply resistance, which causes the substrate itself to generate heat. For example, in the case where one semiconductor wafer generates the current consumption of 1 kA, even the resistance of 1 mΩ results in the heat generation of 1 kW. It is easy to predict that there is the current consumption of 1 kA in one semiconductor wafer 20 at the time of the wafer level burn-in as the miniaturization of the process advances.

The example of the placement of the temperature sensors corresponding to the variation of the alignment positions of the non-defective device and the already-detected defective device on the semiconductor wafer was described earlier. Alternatively, the temperature sensors may be provided in accordance with a rough or thick density of wirings of the wiring layers 34 in consideration of the heat generation in the multi-layer wiring substrate 31a so that an information for uniformly controlling the temperatures in the entire testing environment including the probe and the semiconductor wafer 20 can be provided.

### PREFERRED EMBODIMENT 2

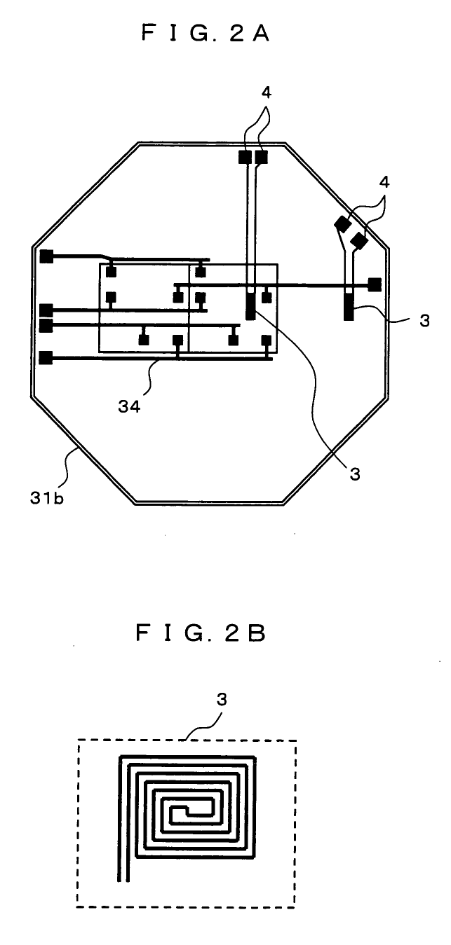

A preferred embodiment 2 of the present invention relates to placement of temperature adjustors. FIG. 2A is a bottom view of a semiconductor test device according to the preferred embodiment 2. FIG. 2B is a specific example of a temperature adjuster 3. A reference symbol 31b denotes a multi-layer wiring substrate. The multi-layer wiring substrate 31b corresponds to the multi-layer wiring substrate 31 in the constitution of FIG. 4 described earlier. A reference numeral 34 denotes a wiring layer of the multi-layer wiring substrate 31b. A reference numeral 3 denotes a temperature adjuster, and numeral 4 denotes a terminal. The rest of the constitution is similar to that of FIG. 4 described earlier, and not described in detail again.

The temperature adjusters 3 are provided on a opposed-wafer surface of the multi-layer wiring substrate 31b. Temperature adjusting surfaces of the temperature adjusters 3 are flush with the opposed-wafer surface and exposed out of the opposed-wafer surface. The terminals 4 are provided in a periphery of the multi-layer wiring substrate 31b. The temperature adjusters 3 and the terminals 4 are connected to each other via the wirings constituting the wiring layer 34. The temperature adjusters 3 are respectively provided in a substantially central part and a part slightly closer to the periphery of the multi-layer wiring substrate 31b. The terminals 4 are provided in association with the respective temperature adjusters 3. The respective temperature adjusters 3 are separately controlled from outside via the terminals 4. The temperature adjusters 3 are provided in such a manner as being exposed to the opposed-wafer surface of the multi-layer wiring substrate 31b so that a temperature of the semiconductor wafer is detected in close vicinity of the semiconductor wafer.

In the wafer level burn-in, an electrical signal and a voltage are supplied to the multi-layer wiring substrate 31b from a burn-in device not shown. The electrical signal and the voltage are supplied to semiconductor devices of the semiconductor wafer via the wirings constituting the wiring layer 34. The semiconductor devices and the multi-layer wiring substrate 31b may be connected in a manner similar to the basic structure shown in FIG. 4 described earlier, however, may be connected otherwise. More specifically, without placing the anisotropic conductive rubber sheet and the flexible substrate, and the wiring layer 34 can be directly arranged in an opposed manner relative to the semiconductor devices to be connected therewith. The latter structure is preferable in order to monitor the actual temperature of the semiconductor wafer at a high accuracy.

The semiconductor devices are thus operated by the supplied electrical signal and voltage to thereby initiate self-heating. The conventional burn-in is often at a temperature at least 100° C., however, the temperature adjusters 3 provided in the multi-layer wiring substrate 31b supports the heat generation when a predetermined temperature cannot be reached by the heat generation of the devices. When the temperature exceeds the predetermined temperature in the self heat generation of the devices, on the contrary, the heat generating part is cooled down to be the predetermined temperature by the temperature adjusters 3. The temperature adjusters 3 are thus directly provided on the opposed-wafer surface of the multi-layer wiring substrate 31b so that the temperature of the semiconductor wafer 20 is controlled in the close vicinity thereof. As a result, a high accuracy can be obtained in the adjustment of the temperature.

There is a method available, for example, in which a resistor constitutes the temperature adjuster 3, and the heat generation is controlled by power applied to the resistance layer. In FIG. 2, the temperature adjusters 3 are provided at the central part and the right-end part of the multi-layer wiring substrate 31b, however, may be provided for each semiconductor device in compliance with the size of each semiconductor device formed on the semiconductor wafer 20. Even though there is the variation of the alignment positions of the non-defective and already-detected defective semiconductor devices in the wafer surface, the temperature adjuster 3 in the close vicinity of the part of the wafer where the already-detected defective device is present is made generate heat to apparently equalize the heat generation in the wafer surface. As a result, the temperature control in the semiconductor wafer 20 can be easily carried out.

The off-leak is increased due to advancement of the miniaturization in the semiconductor in recent years. More specifically, the leakage amount per 1 cm² generates the power consumption of 1-1.5 W. In order to generate a heating value equal thereto, it is necessary to form the resistance of 1 k ohm per 1 cm² on the substrate and impress the current flow of 10 mA.

In the case where a copper wiring constitutes the temperature adjuster 3, for example, a resistivity (specific resistance) at 100° C. is 2.23×10⁻⁸ (Ω·m). Provided that a sectional area is a (mm²), and a length is L (m), a resistance R is calculated in the following equation (3).
R=resistivity×L÷a (3)

In the case where a copper wiring having the thickness of 2 μm and the width of 50 μm constitutes the resistance of 1 kΩ, a wiring length of approximately 50 cm is generally necessary. However, as the wiring having a length of approximately 1 m can actually constitute the resistance, the copper wiring has enough realizable possibility.

In the foregoing description, the temperature adjusters 3 are heat-generated so that the temperature of the wafer surface is controlled to be equal. The temperature adjuster 3 may be a cooling element. When the part where the non-defective device is located is cooled down, an effect similar to that of the heat generation can be obtained.

Though not shown, when the temperature adjusters 3 on the multi-layer wiring substrate 31b and an external temperature adjuster are combined, the temperature adjustment can further achieve a higher accuracy.

### PREFERRED EMBODIMENT 3

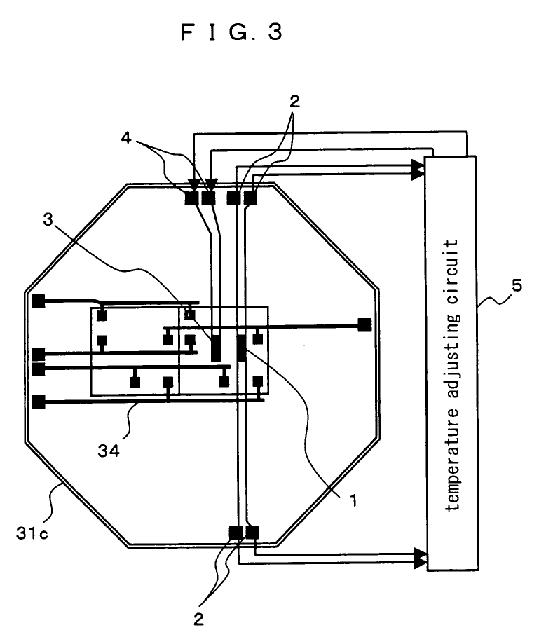

A preferred embodiment 3 of the present invention relates to placement of a temperature sensor and a temperature adjuster. FIG. 3 is a bottom view of a semiconductor test device according to the preferred embodiment 3 combined with a temperature adjusting circuit. In FIG. 3, a reference symbol 31c denotes a multi-layer wiring substrate. The multi-layer wiring substrate 31c corresponds to the multi-layer wiring substrate 31 shown in FIG. 4 described earlier. A reference numeral 34 denotes a wiring layer of the multi-layer wiring substrate 31c. A reference numeral 1 denotes a temperature sensor, and a reference numeral 3 denotes a temperature adjuster. Reference numerals 2 and 4 denote terminals. In the temperature sensor 1, measurement conditions are set from outside via at least one of the terminals 2, and an output of the temperature sensor 1 is outputted outside via at least one of the terminals 2 and monitored. The temperature adjuster 3 is separately controlled from outside via the terminals 4. A reference numeral 5 denotes a temperature adjusting circuit.

The temperature sensor 1 is provided on a opposed-wafer surface of the multi-layer wiring substrate 31c. A testing surface of the temperature sensor 1 is flush with the opposed-wafer surface and exposed to the opposed-wafer surface. The terminals 2 are provided in a periphery of the multi-layer wiring substrate 31c. The temperature sensor 1 and the terminals 2 are connected via the wirings constituting the wiring layer 34. The terminals 2 are connected to the temperature adjusting circuit 5 via a connecting structural component (lead wiring or the like) provided outside of the multi-layer wiring substrate 31c.

The temperature adjuster 3 is provided on the opposed-wafer surface of the multi-layer wiring substrate 31c. A temperature-adjusting surface of the temperature adjuster 3 is flush with the opposed-wafer surface and exposed to the opposed-wafer surface. The terminals 4 are provided in a periphery of the multi-layer wiring substrate 31c. The temperature adjuster 3 and the terminals 4 are connected via the wirings constituting the wiring layer 34. The terminals 4 are connected to the temperature adjusting circuit 5 via a connecting structural component (lead wiring or the like) provided outside of the multi-layer wiring substrate 31c. A temperature detection signal is outputted from the terminals 2 to the temperature adjusting circuit 5, while a condition-setting signal is outputted from the temperature adjusting circuit 5 to the terminals 4.

The temperature adjusting circuit 5 generates the condition-setting signal of the temperature adjuster 3 based on the temperature measured by the temperature sensor 1 and outputs the generated signal to the terminals 4. The temperature adjuster 3 receives the condition-setting signal from the temperature adjusting circuit 5 via the terminals 4 and thereby adjusts the temperature. In this case, because the temperature sensor 1 is provided on the opposed-wafer surface of the multi-layer wiring substrate 31c, the temperature of the semiconductor wafer 20 can be detected in the close vicinity thereof, which increases the accuracy in the temperature measurement. Further, the temperature of the semiconductor wafer can be controlled in the close vicinity thereof because the temperature adjuster 3 is provided on the opposed-wafer surface of the multi-layer wiring substrate 31c, and thereby the temperature adjustment can be carried out at a high accuracy.

While there has been described what is at present considered to be preferred embodiments of this invention, it will be understood that various combinations and arrangements of the components can be changed with respect to the preferred embodiments, and it is intended to cover in the appended claims all such modifications as fall within the true spirit and scope of this invention.

What is claimed is:

1. A semiconductor test device comprising:
a substrate having a opposed-wafer surface on which a semiconductor wafer with a plurality of the embedded semiconductor devices is arranged opposite when a burn-in test is implemented;
a wiring layer provided on the substrate; and
a temperature sensor for measuring a temperature of the semiconductor wafer in the state where the semiconductor wafer is placing opposite on the substrate, wherein
the wiring layer includes a wiring which is connected to the semiconductor wafer in the state where the semiconductor wafer is placing opposite on the substrate, and supply a signal and a voltage for the burn-in test to the semiconductor wafer, and
the temperature sensor is provided on the substrate in vicinity of the opposed-wafer surface.

2. The semiconductor test device according to claim 1, wherein
the temperature sensor is provided on the opposed-wafer surface of the substrate.

3. The semiconductor test device according to claim 1, wherein
the temperature sensor consists of a part of the wiring layer.

4. The semiconductor test device according to claim 1, wherein
a plurality of temperature sensors is provided, and
a location distribution of the plurality of temperature sensors on the substrate corresponds to a wiring distribution density of the wiring layer on the substrate.

5. The semiconductor test device according to claim 1, wherein
a terminal is provided in a periphery of the substrate, and
the temperature sensor and the terminal are connected to each other via the wiring layer.

6. A semiconductor test device comprising:
a substrate having a opposed-wafer surface on which a semiconductor wafer embedded a plurality of semiconductor devices is provided in an opposed manner when a burn-in test is implemented;
a wiring layer provided on the substrate; and
a temperature adjuster for adjusting a temperature of the semiconductor wafer in the state where the semiconductor wafer is placing opposite on the substrate, wherein
the wiring layer includes a wiring which is connected to the semiconductor wafer in the state where the semiconductor wafer is placing opposite on the substrate, and supplies a signal and a voltage for the burn-in test to the semiconductor wafer, and
the temperature adjuster is provided on the substrate in vicinity of the opposed-wafer surface.

7. The semiconductor test device according to claim 6, wherein
the temperature adjuster is provided on the opposed-wafer surface of the substrate.

8. The semiconductor test device according to claim 6, wherein
the temperature adjuster consists of a part of the wiring layer.

9. The semiconductor test device according to claim 6, wherein
a plurality of temperature adjusters is provided, and
the plurality of temperature adjusters is each constructed so as to be able to separately adjust the temperature.

10. The semiconductor test device according to claim 9, wherein
the number of the temperature adjusters and an adjustment capacitance of the respective temperature adjusters are set based on a size of the semiconductor wafer, a size of the respective semiconductor devices, and power consumption of the semiconductor devices.

11. The semiconductor test device according to claim 6, wherein
a terminal is provided in a periphery of the substrate, and
the temperature adjuster and the terminal are connected to each other via the wiring layer.

12. A semiconductor test device comprising:
a substrate having a opposed-wafer surface on which a semiconductor wafer embedded a plurality of semiconductor devices is provided in an opposed manner when a burn-in test is implemented;
a wiring layer provided on the substrate;
a temperature sensor for measuring a temperature of the semiconductor wafer in the state where the semiconductor wafer is placing opposite on the substrate;
a temperature adjuster for adjusting the temperature of the semiconductor wafer in the state where the semiconductor wafer is placing opposite on the substrate, wherein
the wiring layer includes a wiring which is connected to the semiconductor wafer in the state where the semiconductor wafer is placing opposite on the substrate, and supplies a signal and a voltage for the burn-in test to the semiconductor wafer,
the temperature sensor and the temperature adjuster are provided on the substrate in vicinity of the opposed-wafer surface, and
the burn-in test is implemented while the temperature of the semiconductor wafer is being adjusted by the temperature adjuster based on the temperature of the semiconductor wafer measured by the temperature sensor.

13. The semiconductor test device according to claim 12, wherein
the temperature sensor and the temperature adjuster are provided on the opposed-wafer surface of the substrate.

14. The semiconductor test device according to claim 12, wherein
the temperature sensor and the temperature adjuster consist of a part of the wiring layer.

15. The semiconductor test device according to claim 12, wherein
a plurality of terminals is provided in a periphery of the substrate,
the temperature sensor and one of the terminals are connected to each other via the wiring layer, and
the temperature adjuster and the other terminal are connected to each other via the wiring layer.
